(19) United States
(12) Patent Application Publication
(10) Pub. No.: US 2006/0225223 A1
(43) Pub. Date: Oct. 12, 2006

(54) Coloring method of natural leather and colored natural leather using the same

(76) Inventor: Jin-Sup Rhee, Seoul (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 10/568,034

(22) PCT Filed: Aug. 11, 2003
(86) PCT No.: PCT/KR03/01609

§ 371 Date: Feb. 10, 2006

(51) Int. Cl. C14C 1/00

(52) U.S. Cl. 8/94.15

(57) ABSTRACT

The present invention discloses a coloring method of a natural leather and a colored natural leather using the same. The coloring method includes the steps of: putting the natural leather having a colored layer formed on one face thereof together with a releasing paper having an aqueous polyurethane layer and an adhesive layer sequentially coated thereon so that the colored layer and the adhesive layer are faced to be in contact with each other; and removing the releasing paper from the aqueous polyurethane layer. The colored natural leather includes an aqueous polyurethane layer; an adhesive layer formed on an upper surface of the aqueous polyurethane layer; a colored layer having various colors of pattern, formed on an upper surface of the adhesive layer; and a natural leather formed on an upper surface of the colored layer.

### TECHNICAL FIELD

The present invention relates to a coloring method of a natural leather and the natural leather colored in various natural colors using the same, in which the natural leather is capable of naturally being colored in various colors, and more particularly, in which the natural leather is capable of being colored in various colors without flowing or running of a colored dye, and much more particularly, in which though a time lapses, an original color of the colored natural leather can remain unchanged as it is without the colored dye not running.

### BACKGROUND ART

In a conventional coloring method of natural leather, a natural color can be realized, but due to a problem on the forming process of a colored layer, there exists a difficulty in realizing the natural color in the colored layer.

In detail, as the time lapses, since the colored dye on the natural leather runs to cause an originally colored design not to be maintained as it is, an original pattern or color of the colored layer is decolorized, discolored, and tarnished to cause the original pattern or color not to be maintained as it is.

Further, since a conventional natural leather does not have a high fastness in an original state thereof, it has a disadvantage in which a surface of the natural leather is stripped off even by a scratch working by a little force.

Accordingly, the present invention provides a coloring method of a natural leather and the colored natural leather using the same, in which various colors can be realized in the same design as that of a general fibrous cloth and further the high fastness is provided for the natural leather.

On the other hand, an invention for an application number PCT/KR02/01428 titled as “dyeing method of synthetic leather” has been already filed by the applicant of the present invention. The dyeing method of the synthetic leather provides detailed method to improving to allow the synthetic leather to be capable of being dyed in various colors.

Further to the dyeing method of the synthetic leather, the present invention provides a dyeing method of the natural leather and the natural leather realized using the same, in which the natural leather can be colored in various colors.

### DISCLOSURE OF THE INVENTION

Accordingly, the present invention is directed to a coloring method of a natural leather and a colored natural leather using the same that substantially obviate one or more problems due to limitations and disadvantages of the related art.

An object of the present invention is to provide a coloring method of a natural leather and a colored natural leather using the same, in which various colors can be realized in the same design as that of a general fibrous cloth in and further a high fastness is provided for the natural leather.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure. particularly pointed out in the written description and claims hereof as well as the appended drawings.

To achieve these objects and other advantages and in accordance with the purpose of the invention, as embodied and broadly described herein, there is provided a coloring method of a natural leather, including the steps of: putting the natural leather having a colored layer formed on one face thereof together a releasing paper having an aqueous polyurethane layer and an adhesive layer sequentially coated thereon so that the colored layer and the adhesive layer are faced to be in contact with each other; and removing the releasing paper from the aqueous polyurethane layer.

In another aspect of the present invention, a coloring method of a natural leather, including the steps of: coating and drying an upper surface of a natural leather with an adhesive; coating an upper surface of the adhesive layer formed by drying the adhesive with a superfine yarn powder, to form a superfine yarn powder layer; and forming a colored layer having a pattern, on an upper surface of the superfine yarn powder layer.

In a further another aspect of the present invention, there is a colored natural leather including an aqueous polyurethane layer; an adhesive layer formed on an upper surface of the aqueous polyurethane layer; a colored layer having various colors of pattern, formed on an upper surface of the adhesive layer; and a natural leather formed on an upper surface of the colored layer.

In still another aspect of the present invention, there is a colored natural leather including: a natural leather; an adhesive layer formed on an upper surface of the natural leather; and a superfine yarn powder layer colored through a predetermined method and formed on an upper surface of the adhesive layer.

According to the present invention, a natural leather can be colored in various colors, and colors of the natural leather can be unchanged without variation. Also, a fastness of the natural leather can be much more increased.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a view illustrating a coloring method of a natural leather according to a first embodiment of the present invention;

FIG. 2 is a view illustrating a coloring method of a natural leather according to a second embodiment of the present invention;

FIG. 3 is a view illustrating a coloring method of a natural leather according to a third embodiment of the present invention;

FIG. 4 is a view illustrating a coloring method of a natural leather according to a fourth embodiment of the present invention; and

FIG. 5 is a view illustrating a coloring method of a natural leather according to a fifth embodiment of the present invention.

### BEST MODE FOR CARRYING OUT THE INVENTION

Reference will now be made in detail to the preferred embodiments of the present invention, examples of which are illustrated in the accompanying drawings.

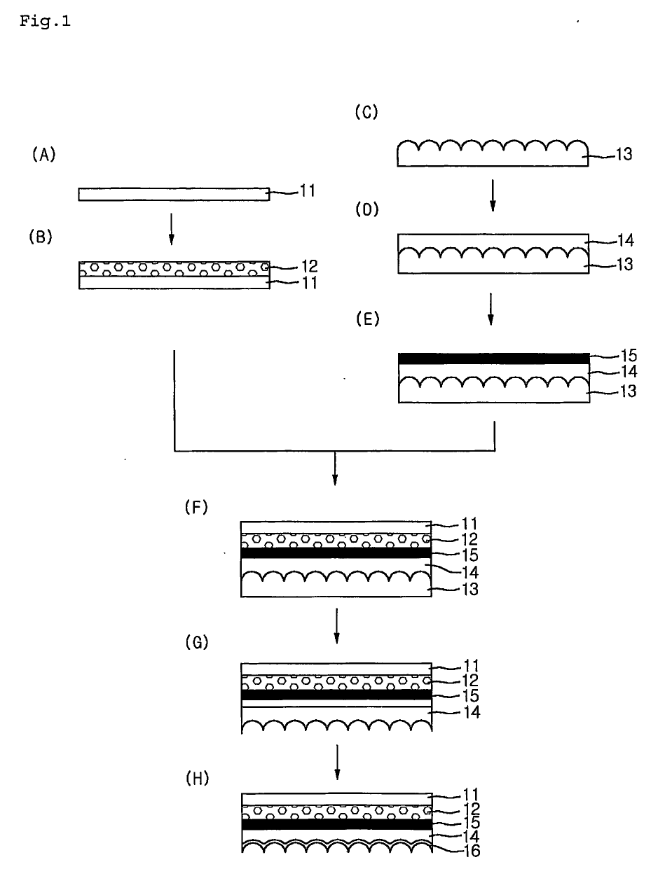

FIG. 1 is a view illustrating a coloring method of a natural leather according to a first embodiment of the present invention.

FIG. 1A illustrates a section of a natural leather 11, and more particularly, the natural leather 11 can use a corium or an endothelium of the natural leather. FIG. 1B illustrates a colored layer 12 formed on one face of the natural leather 11 to form a variously colored pattern therein.

A forming method of the colored layer 12 can use one of many methods for transferring the variously colored pattern, for example, a wet-etch transfer dyeing method, a silk transfer dyeing method, a screen transfer dyeing method, a sublimation transfer dyeing method and a computer screen transfer dyeing method.

FIG. 1C illustrates a section of a releasing paper 13 having an embossing pattern on one face thereof, and FIG. 1D illustrates an aqueous polyurethane layer 14 mainly consisting of PolyUrethane (P.U.) further formed on an embossing pattern face of the releasing paper 13.

A composition and a forming method of the aqueous polyurethane layer 14 will be described in detail in the last of the descriptions.

After the aqueous polyurethane layer 14 is coated, the coated polyurethane layer 14 is dried for dry-hardening for 1˜5 minutes at a temperature of 50˜150° C.

Referring to FIG. 1E, an adhesive layer 15 is further formed on the aqueous polyurethane layer 14 so that the natural leather 11 is adhered thereto. The resultants are dried to allow the adhesive layer 15 to be dried to some extents, for 1˜5 minutes at the temperature of 50˜150° C. A composition and a forming method of the adhesive layer 15 will be described in detail in the last of the descriptions for the first embodiment together with the aqueous polyurethane layer 14.

Next, both laminates of FIGS. 1B and 1E are put together as shown in FIG. 1F. Describing the section of the resultant laminates, the resultant laminates are sequentially comprised of the releasing paper 13 having the embossing pattern formed in a lowest layer, the aqueous polyurethane layer 14 formed on the releasing paper 13, the adhesive layer 15 formed on the aqueous polyurethane layer 14, the colored layer 12 formed on the adhesive layer 15, and the natural leather 11 formed on the colored layer 12.

After that, the resultant laminates are dried for 1˜5 minutes at the temperature of 50˜150° C. via a thermal chamber, and again ripen for 6˜48 hours at the temperature of 50˜90° C.

Next, as shown in FIG. 1G, the releasing paper 13 is removed.

After that, as shown in FIG. 1G, a surface treatment is performed on a surface of the aqueous polyurethane 14. In detail, chemicals such as nubuck, amino, wax, etc. is applied to form a surface treatment layer 16 on the surface of the aqueous polyurethane 14. The surface of the natural leather is process-treated to be smooth so that the surface treatment layer 16 reduces a hard sense of a cowhide and has a soft sense of a sheepskin. Further, wax, etc. can provide the surface of the natural leather with a quality sense of sliding or glittering. On the other hand, the chemicals such as nubuck, amino, wax, etc. can be sprayed by a sprayer.

On the other hand, since the aqueous polyurethane layer 14 can have a strong fastness differently from the natural leather 11, the present invention has an effect of much more increasing the fastness of the natural leather.

In addition, the surface of the aqueous polyurethane 14 can be also formed by a buffering process of rubbing the aqueous polyurethane layer 14 using a sandpaper, etc. as well as the chemicals such as nubuck, amino, wax, etc. A physical process such as the buffering process, etc. can allow the surface of the natural leather to have other quality senses.

Hereinafter, a material, a property and a forming method of the aqueous polyurethane layer 14 and the adhesive layer 15 will be described in detail.

The material of the aqueous polyurethane layer 14 can use a first PolyUrethane (P.U.) and a second PolyUrethane (P.U.), individually as well as a combination thereof.

The first P.U. is a first liquid-type resin of an aqueous polyurethane having the property in which a viscosity is below 50 cps/25±1° C., a solid powder is within a range of 29˜31%, a 100% modulus is within a range of 35˜40 kgf/cm², and an elongation ratio is within a range of 700˜800%. And, the second P.U. is the aqueous polyurethane having the property in which the viscosity is below 1000˜2500 cps/25±1° C., the solid powder is 25%, and a water can be used as a solvent.

The first P.U. and the second P.U. can be agitated in an agitator to adjust a final viscosity within a range of 6000˜10000 cps/R.T. Further, in order to supplement the viscosity, an aqueous toner can be further added. Similarly, after a series of forming process is completed for the material of the aqueous polyurethane layer 14, since a preparation for coating the releasing paper 13 is completed, the coating process of the material of the aqueous polyurethane layer 14 can be performed on the releasing paper 13. For example, a weight ratio of the first P.U., the second P.U. and the aqueous toner is as follows. That is, when the first P.U. is a weight ratio of 100, the second P.U. can be a weight ratio of 1˜2 and the aqueous toner can be a weight ratio of 20.

On the other hand, so as to prevent the combined aqueous polyurethane from being crystallized, a citric acid and an amino acid can be further added to the combined aqueous polyurethane. Further, in case the combined aqueous polyurethane is left alone for a long time more than three days, since the first P.U. and second P.U. may be separated from each other, it is desirable to use the aqueous polyurethane after agitated.

A material of the adhesive layer 15 uses a combination of three adhesive materials. A first adhesive is a second liquid-type resin of the aqueous polyurethane not using the solvent and having the property in which the viscosity is below 500 cps/25±1° C., the solid powder is within a range of 42˜44%, the 100% modulus is within a range of 30˜35 kgf/cm², the elongation ratio is within a range of 400˜600%, and the elongation strength is within a range of 300˜400 kgf/cm². And, a second adhesive is the aqueous polyurethane having the property in which the viscosity is below 1000˜2500 cps/25±1° C. and the solid powder is 25%. Last, a third adhesive is the aqueous polyurethane serving as a hardening agent and having the property in which the viscosity is below 300˜1000 cps/25±1° C., the solid powder is 97˜99%, an NCO% can use a combination of 20.0%˜21.2% materials. Further, respective composition ratios are that when the first adhesive is a composition ratio of 100, the second adhesive is a composition ratio of 0.5˜1 and the third adhesive is a composition ratio of 8˜12.

As described above, after the materials of the aqueous polyurethane layer 14 and the adhesive layer 15 are formed, coating processes of the materials are performed. However, as a coating condition of the materials of the aqueous polyurethane layer 14, in order to regularize a thickness of the aqueous polyurethane 14 for a whole surface thereof, the material of the aqueous polyurethane layer 14 can be coated using two or more times of continuous repetitive coating processes. However, when one layer is formed on the underlying other layer, it is desirable to coat the one layer on the underlying other layer after the underlying other layer is hardened to some extent.

On the other hand, since the above-described materials of the aqueous polyurethane layer 14 and the adhesive layer 15 use the polyurethane not having dimethyl formamide(DMF) and methylethyl ketone (MEK), the pattern of the colored layer is maintained, though the time lapses, with the original colors remaining as it is. The above-descriptions can be applied identically with the following descriptions.

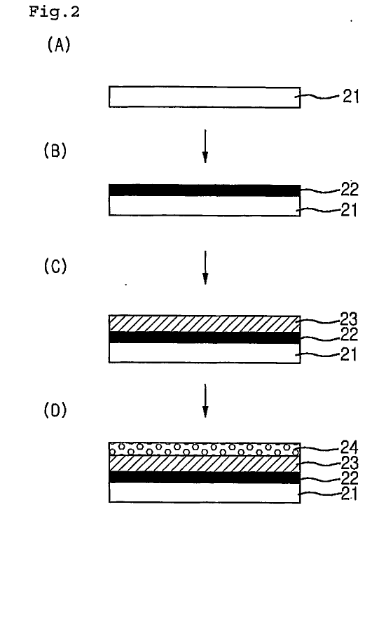

FIG. 2 is a view illustrating the coloring method of the natural leather according to a second embodiment of the present invention.

Referring to FIG. 2, FIG. 2A illustrates the corium or the endothelium of the natural leather 21, and FIG. 2B illustrates an adhesive layer 22 formed on the natural leather 21. A material of the adhesive layer 22 can use the combined materials of adhesive described in FIG. 1. After the adhesive layer 22 is coated, the coated adhesive layer 22 is dried for 1˜5 minutes at the temperature of 50˜150° C. And, referring to FIG. 2C, a superfine yarn powder layer 23 is formed on the adhesive layer 22. The superfine yarn powder layer 23 can be formed by the step of coating the adhesive layer 22 with the superfine yarn powder of the natural leather or the superfine yarn powder of the synthetic fiber, and the coated superfine yarn powder can be firmly adhered by the adhesive layer 22.

Referring to FIG. 2D, the colored layer 24 is formed on the superfine yarn powder layer 23, and the colored layer 24 can be formed in the pattern including a plurality of colors. In detail, the coloring method can use one of the sublimation transfer method, the screen transfer method, the silk transfer method, the computer screen transfer method and the wet-etch transfer method.

Preferably, the sublimation transfer method can be performed for 3˜25 seconds at a temperature of 80˜250° C.

Accordingly, the above coloring method can provide the same effect as that of coloring the natural leather as viewed in consumer's eyes.

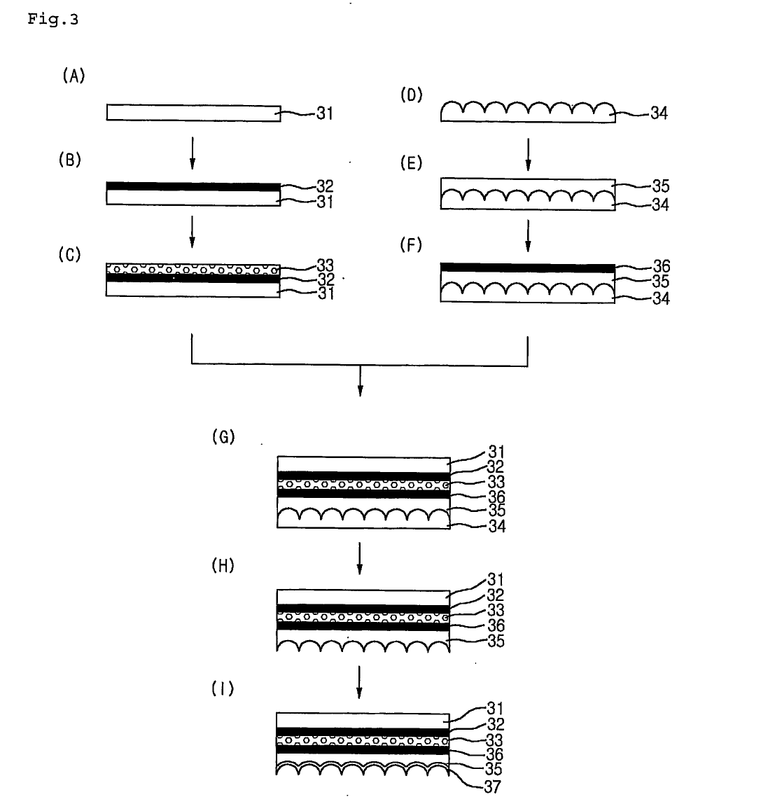

FIG. 3 is a view illustrating the coloring method of the natural leather according to a third embodiment of the present invention.

Referring to FIG. 3, also in the third embodiment of the present invention, the adhesive layer and the aqueous polyurethane layer can be employed having the same property of the material and the same forming method as in the first embodiment of the present invention.

In the third embodiment, a releasing paper 34, an aqueous polyurethane layer 35, a second adhesive layer 36 and a natural leather 31 are used in the same as in the first embodiment of the present invention. However, the colored layer (referring to reference numeral 12 of FIG. 1) is not formed on one face of the natural leather 31 by the sublimation transfer method, etc., the third embodiment is different from the first embodiment in that after the adhesive layer 32 is formed on one face of the natural leather 31 and dried for 1˜5 minutes at the temperature of 50˜150° C., a coloring process is performed by a design textile 33.

The design textile 33 can use a thin film colored in various colors, and the material and the property of the design textile can use various kinds of a paper, a fiber, a plastic, etc.

A non-described reference numeral 37 indicates a surface treatment layer.

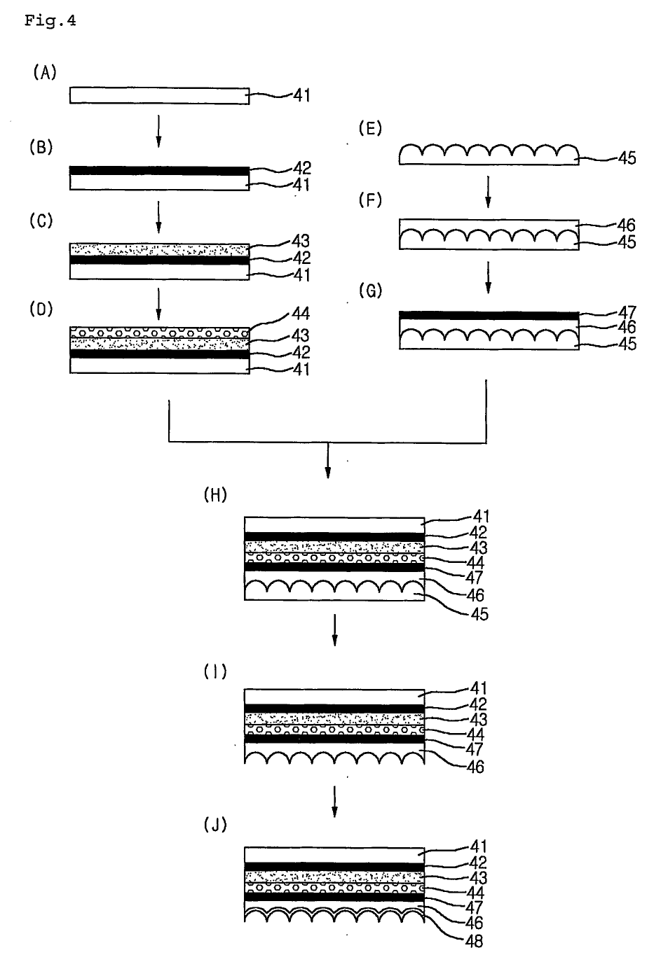

FIG. 4 is a view illustrating the coloring method of the natural leather according to a fourth embodiment of the present invention.

The fourth embodiment is the same as the third embodiment in many parts, excepting the forming method of the colored layer. In detail, as shown in FIG. 4C and FIG. 4D, after the adhesive layer 42 is formed, a wet-etch dipping layer 43 is formed on the adhesive layer 42. The wet-etch dipping layer 43 can be formed by the step of after a thick film of the adhesive layer 42 is formed, dipping and ripening the adhesive layer 42 in a proper temperature of water. In addition to this, after the adhesive layer 42 is coated and dried, a new aqueous polyurethane layer can be additionally formed and dipped in the proper temperature of water to form the wet-etch dipping layer 43. The wet-etch dipping layer 43 allows the physical property of the natural leather to be smooth so that a good quality of natural leather can be obtained.

Further, through the above-described coloring methods such as the sublimation transfer method, etc., the colored layer 44 is formed on the wet-etch dipping layer 43, and the colored layer 44 and the adhesive layer 47 are put together facing opposite to each other.

A non-described reference numeral 41 indicates the natural leather, 45 indicates the releasing paper, 46 indicates the aqueous polyurethane layer, and 48 indicates the surface treatment layer.

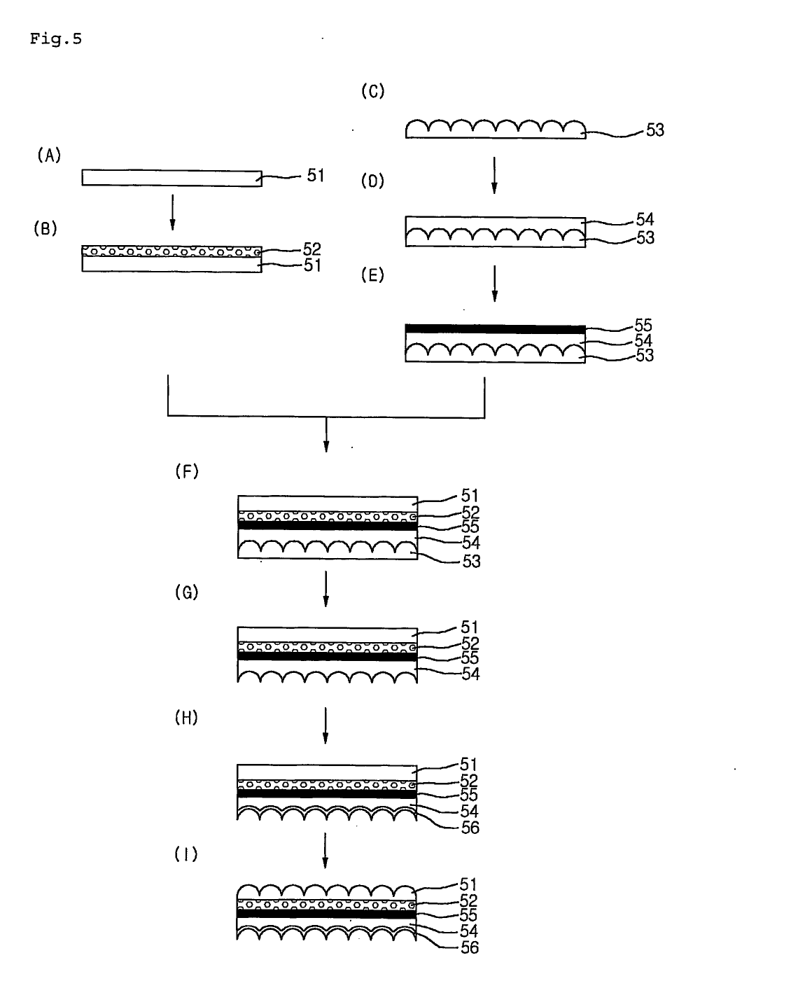

FIG. 5 is a view illustrating the coloring method of the natural leather according to a fifth embodiment of the present invention.

The inventive fifth embodiment is the same as the first embodiment in many parts, excepting that the embossing pattern is formed on an upper surface of the natural leather 51. Besides, treatment of the aqueous polyurethane layer and treatment of the natural leather are the same as in the first embodiment.

In detail, after the series of processes are performed starting from the steps of FIG. 5A and FIG. 5C, as shown in FIG. 5H, a surface treatment layer 56, an aqueous polyurethane layer 54, an adhesive layer 55, a colored layer 52 and a natural leather 51 are stacked to form the colored natural leather. On the other hand, the releasing paper 53 is separated and removed in the coloring process of the natural leather.

As shown in FIG. 5H, after the coloring is all completed, if the surface of the natural leather 51 is suppressed to a predetermined mold, a predetermined embossing pattern can be formed on the upper surface of the natural leather 51. The suppressing process can allow the original quality sense of the natural leather to be recovered more perfectly.

Further, in case the embossing pattern is formed on the releasing paper 53, the embossing pattern can be formed even on the aqueous polyurethane layer 54.

Furthermore, the embossing pattern is not formed on the releasing paper 53 so that the aqueous polyurethane layer 54 does not have the embossing pattern formed thereon, and further the aqueous polyurethane layer 54 is faced and suppressed to the predetermined mold in the same manner as the natural leather 51, the aqueous polyurethane layer 54 has the embossing pattern formed thereon.

FIG. 5I illustrates a state of the natural leather in which the releasing paper 53 has the embossing pattern formed thereon to allow the embossing pattern to be formed on the aqueous polyurethane layer 54, and in which the natural leather 51 is suppressed to have the embossing pattern formed even on the natural leather 51.

### INDUSTRIAL APPLICABILITY

As appreciated from the above-described embodiments, the present invention puts the aqueous polyurethane layer consisting of the polyurethane and the adhesive layer together the natural leather to allow the color not to run by the aqueous polyurethane layer so that the natural leather can be colored. Further, the aqueous polyurethane can be used to increase the whole fastness and strength of the natural leather.

The present invention has an advantage of coloring the natural leather in various colors so that whatever pattern desired by the consumer can be colored, to thereby much more increasing a usefulness of the natural leather.

Further, the present invention provides the effect of being capable of using the aqueous polyurethane as a protective layer of the natural leather to realize the strong fastness and strength, which cannot be achieved by only the natural leather.

Furthermore, the present invention provides another advantage in which the surface treatment is additionally performed on the natural leather so that various quality sense, etc. can be realized to much more increase an aesthetic sense of a user.

It will be apparent to those skilled in the art that various modifications and variations can be made in the present invention. Thus, it is intended that the present invention covers the modifications and variations of this invention provided they come within the scope of the appended claims and their equivalents.

1. A coloring method for a natural leather, the method comprising the steps of:
putting the natural leather having a colored layer formed on one face thereof together with a releasing paper having an aqueous polyurethane layer and an adhesive layer sequentially coated thereon so that the colored layer and the adhesive layer are faced to be in contact with each other; and
removing the releasing paper from the aqueous polyurethane layer.

2. The coloring method of claim 1, wherein the colored layer is colored through one of a wet-etch transfer method, a screen transfer method, a sublimation transfer method, a silk transfer method, and a computer screen transfer method.

3. The coloring method of claim 1, further comprising the step of: after the releasing paper is removed, forming a surface treatment layer by performing a surface-treatment process on the aqueous polyurethane layer from which the releasing paper is removed

4. The coloring method of claim 1, wherein the releasing paper has an embossing pattern formed thereon.

5. The coloring method of claim 1, wherein an adhesive forming the adhesive layer and/or an aqueous polyurethane forming the aqueous polyurethane layer are/is an aqueous polyurethane not containing dimethyl formamide and methylethyl ketone.

6. The coloring method of claim 1, further comprising the step of: suppressing the natural leather and/or the aqueous polyurethane layer to a predetermined mold to form an embossing pattern thereon.

7. The coloring method of claim 1, wherein the colored layer is formed by the steps of:
forming the adhesive layer facing to be in contact with an upper surface of the natural leather; and
forming a design textile having a predetermined pattern, on an upper surface of the adhesive layer.

8. The coloring method of claim 1, further comprising the steps of:
forming the adhesive layer on the upper surface of the natural leather between the colored layer and the natural leather; and
forming a wet-etch dipping layer on the upper surface of the adhesive layer.

9. The coloring method of claim 1, further comprising the steps of:
forming the adhesive layer between the colored layer and the natural leather; and
wet-etch dipping the adhesive layer to form the wet-etch dipping layer on the adhesive layer.

10. The coloring method of claim 1, further comprising the steps of:
forming the adhesive layer between the colored layer and the natural leather; and
coating and wet-etch dipping a new aqueous polyurethane layer to form the wet-etch dipping layer on the adhesive layer.

11. The coloring method of claim 1, wherein the aqueous polyurethane layer is formed by repetitively coating with the aqueous polyurethane in a predetermined time interval.

12. A coloring method for a natural leather, comprising the steps of:
coating and drying an upper surface of a natural leather with an adhesive;
coating an upper surface of the adhesive layer formed by drying the adhesive with a superfine yarn powder, to form a superfine yarn powder layer; and forming a colored layer having a pattern, on an upper surface of the superfine yarn powder layer.

13. The coloring method of claim 12, wherein the colored layer is colored through one of a screen transfer method, a sublimation transfer method, a silk transfer method, and a computer screen transfer method.

14. A colored natural leather comprising:
an aqueous polyurethane layer;
an adhesive layer formed on an upper surface of the aqueous polyurethane layer;
a colored layer having various colors of pattern, formed on an upper surface of the adhesive layer; and
a natural leather formed on an upper surface of the colored layer.

15. The colored natural leather of claim 14, further comprising a surface treatment layer surface-treated by a chemical method, beneath the aqueous polyurethane layer.

16. The colored natural leather of claim 14, wherein the colored layer comprises:
a design textile having a pattern drawn thereon and facing to be in contact with the adhesive layer; and
another adhesive layer formed on an upper surface of the design textile.

17. The colored natural leather of claim 14, wherein the aqueous polyurethane layer and/or the natural leather are/is suppressed on a predetermined mold to form an embossing pattern thereon.

18. The colored natural leather of claim 14, wherein the colored layer is formed on an upper surface of a wet-etch dipping layer formed by dipping the adhesive layer.

19. The colored natural leather of claim 14, wherein the colored layer if formed by wet-etch dipping the another aqueous polyurthane layer addicitonally formed on the adhesive layer.

20. A colored natural leather comprising;
a natural leather;
an adhesive layer formed on an upper surface of the natural leather; and
a superfind yarn powder layer colored through a predetermined method and formed on an upper surface of the adhesive layer.
